(19) United States
(12) Patent Application Publication
(10) Pub. No.: US 2005/0283480 A1
(43) Pub. Date: Dec. 22, 2005

(54) System and method for media distribution in a physical area

(76) Inventors: Erik Berglund, Linkoping (SE); Magnus Bang, Linkoping (SE); Magnus Irestig, Linkoping (SE)

Correspondence Address: ERICSSON INC., 6300 LEGACY DRIVE, M/S EVR C11, PLANO, TX, 75024, US

(21) Appl. No.: 10/520,808

(22) PCT Filed: Jun. 30, 2003
(86) PCT No.: PCT/SE03/01140

§ 371 Date: Jul. 14, 2005

(30) Foreign Application Priority Data
Jul. 12, 2002 (SE) 0202192-1

(51) Int. Cl. G06F 7/00; G06F 17/30; G06F 15/16; H04B 7/00

(52) U.S. Cl. 707/10; 709/200; 370/310

(57) ABSTRACT

The present patent application relates to a system and method for media distribution in a physical area (1). The system comprises at least one uniquely identifiable first type tag (2), which can be carried around said physical area (1) by a user being visitor thereto and at least one uniquely identifiable second type tag (3), identifying a media access point in said physical area (1). Further comprised in the system is an administrative system (4) and communication means (5, 7, 8). At least one of said first and second type tags (2, 3) has means (6) for identifying combinations of first and second type tags brought into close proximity of each other and communicate information relating to these tags to the administrative system (4). The administrative system (4) is arranged to respond to this information through distributing to communication means (7, 8) associated with either of these tags media determined by the received information.

### TECHNICAL FIELD

The present patent application relates to a system for media distribution in a physical area comprising at least one uniquely identifiable tangible first type tag, which can be carried around said physical area by a user being visitor thereto and at least one uniquely identifiable tangible second type tag, identifying a media access point in said physical area. Particularly, the patent application relates to a system for distribution of media adapted to a user being visitor to the physical area. The present patent application also relates to a method for media distribution in a physical area comprising the steps of providing at least one uniquely identifiable tangible first type tag, which can be carried around said physical area by a user being visitor thereto and providing at least one uniquely identifiable tangible second type tag, identifying a media access point in said physical area. Particularly, the patent application relates to a method for distribution of media adapted to a user being visitor to the physical area.

### BACKGROUND OF THE INVENTION

It has recently been proposed to associate tangible media with computer networks.

A number of different systems have been developed to allow tangible media to be associated with computer networks. One such system is previously known through US 2001 0 021 950, where interaction with a computer network is facilitated or restricted based on a tangible token, such as a small card or disk, a small everyday article, a toy, or a product container, where the token comprises a machine-readable indication, or “tag,” that identifies the token and which may be wirelessly read by a tag reader, whereupon the tag reader communicates the identifier to a computer connected to the network as a node and the computer, in response, determines and implements a network-access criterion based on the token, the computer maintaining a database relating token identifiers to associated network-access criteria, and consulting the database when presented with an identifier, and where the access criterion specifies information governing interaction between the computer and the network, and can serve to initiate connections or restrict them.

However, the above system relates only to providing access criteria to said computer.

### SUMMARY OF THE INVENTION

One object of the invention is to provide a system allowing for media distribution in a physical area. This object is achieved by means of a system for media distribution in a physical area comprising: at least one uniquely identifiable tangible first type tag; which can be carried around said physical area by a user being visitor thereto; at least one uniquely identifiable tangible second type tag, identifying a media access point in said physical area; an administrative system; and communication means; wherein, at least one of said tangible first and second type tags has means for identifying combinations of tangible first and second type tags brought into close proximity of each other and communicate information relating to these tangible tags to the administrative system; and said administrative system being arranged to respond to this information through distributing to communication means associated with either of these tangible tags media determined by the received information.

A further object of the invention is to provide a method allowing for media distribution in a physical area. This object is achieved by means of a method for media distribution in a physical area comprising the steps of: providing at least one uniquely identifiable tangible first type tag, which can be carried around said physical area by a user being visitor thereto; providing at least one uniquely identifiable tangible second type tag, identifying a media access point in said physical area; providing an administrative system; providing communication means; providing at least one of said tangible first and second type tags with means for identifying combinations of tangible first and second type tags brought into close proximity of each other and means for communicating information relating to these tangible tags to the administrative system; arranging said administrative system to respond to this information through distributing to communication means associated with either of these tangible tags media determined by the received information.

Preferred embodiments are listed in the dependent claims.

### DESCRIPTION OF DRAWINGS

In the following, the invention will be described in greater detail with reference to attached drawings, in which

FIG. 1 is a schematic illustration of a system according to a first embodiment of the invention,

FIG. 2 is a schematic flow sheet illustrating use of the system for media distribution in physical areas according to FIG. 1.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that, the drawings are not necessarily drawn to scale and that unless otherwise indicated, they are merely intended to conceptually illustrate the structures and procedures described herein.

### DESCRIPTION OF EMBODIMENTS

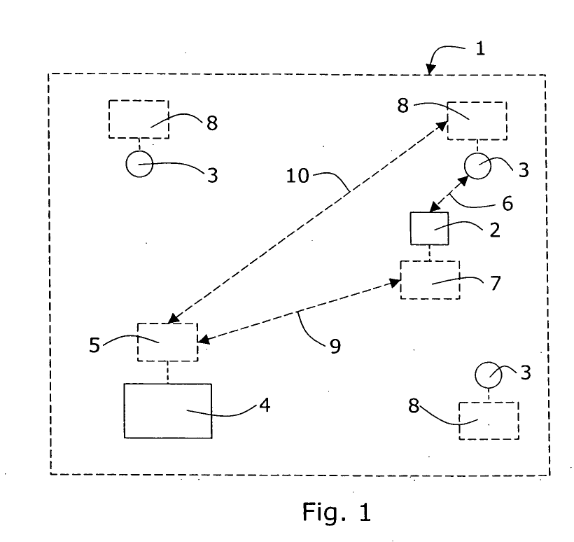

FIG. 1 shows a system for media distribution in a physical area 1. In a preferred embodiment of the invention, the system comprises a uniquely identifiable first type tag 2, which can be carried around said physical area 1 by a user being visitor thereto. Additional first type tags can be carried by additional users being visitors to the same physical area, but for reasons of clarity FIG. 1 shows only one. Further, a number of uniquely identifiable second type tags 3, are located to different locations or physical objects in said physical area 1 and identifies media access points in said physical area 1. It is further possible that the physical objects, to which the second type tags 3 can be located, are moveable or otherwise arranged such that they can alter their position within said physical area 1. An administrative system 4 which is associated with communication means 5 is provided by the system. At least one of said first and second type tags 2, 3 has means for identifying combinations of first and second type tags brought into close proximity of each other, in FIG. 1 represented by the interconnecting arrow 6. These means 6 can be realized as wireless communications means such as infrared communication means, e.g. IRDA, or low-power radio-frequency (RF) communication means, e.g. Blue Tooth or wireless local area network (WLAN) communication means or radio-frequency identification (RFID) communication means. They can also be realized as combinations of readers and identifiers, such as bar-code readers and printed bar-codes or manual input devices, such as numerical keyboards, and printed codes. As a further alternative these means 6 can be realized as combinations of biosensors and user body parts, e.g. fingerprint readers and a finger of the user or retinal recognition devices and an eye of the user. Once a combination of tags have been identified to be in close proximity of each other information relating to these tags can be communicated to the administrative system 4 using communication means 7, 8 associated with either of said tags 2, 3. In FIG. 1 this communication is represented by either of the broken arrows 9, 10. It is also possible to allow the user to determine if this information is to be communicated. In the case of automated proximity detection, it might be necessary to request the user to OK communication of information to the administrative system 4 while in the case of readers or manual input, use thereof can be deemed as such an OK. Once such information is received by the administrative system 4, the administrative system is arranged to respond to this information through compiling and distributing to communication means 7, 8 associated with either of these tags 2, 3, media determined by the received information, e.g. a media session determined by the second type tag 3 which can be personalized based upon the identity provided by the first type tag 2. The degree of personalization possible is determined by the amount of data provided to the administrative system and associated with the first type tag 2 when allocating a first type tag 2 to a specific user. The distribution of media is illustrated by either of the broken arrows 9, 10 in FIG. 1. The communication means 7, 8 can either be a portable communications means 7 associated with the first type tag 2 carried by the user, such as a personal mobile phone, personal digital assistant or laptop personal computer connected to communication means, i.e. communication means associated with means enabling presentation of media to the user, or communication means 8 associated with the second type tag(s) 3 involved, and these latter communication means 8 can possibly also be associated with means for presentation of the media (not shown) to the user arranged in proximity of the second type tag(s) 3, such as audio-visual presentation means, e.g. computer screens, audio systems, video presentation systems etc. The communication means can be arranged to communicate over a wired system or a wireless network. In the case of the portable communication means 7 being a mobile phone it is further possible to provide the unique tag identification from the subscriber identity module, i.e. SIM-card, of said mobile phone or associate it therewith.

In a further embodiment it is envisaged to extend software event structures to include tangible objects or locations represented by the second type tags 3 as carriers and activators of events. This is achieved through embedding computer-readable events into the second type tags 3 and allowing them to be sent to an event manager process residing either in the administrative system 4 or associated with the portable communication means 7 associated with the first type tag 2 or possibly also associated with the communication means 8 associated with the second type tag(s) 3. Hereby events may be activated and sent to the event manager process, without prior knowledge of the event structure.

According to yet a further embodiment it is envisaged to integrate the administrative system 4 in a portable communication means 7, such as a personal mobile phone, associated with the first type tag 2, possibly through downloading and executing said administrative system 4 on the communication means 7. The communication means 7 can also comprise or be associated with means for presenting audio or audio-visual media.

In yet a further embodiment it is envisaged to provide said first type tag 2 with means (not shown) for facilitating determination of a user identity to said system. This is achieved through providing the first type tag 2i or the communication means associated therewith 7, with identification means, such as biosensors, e.g. a fingerprint reader or a retinal recognition device, or readers for identity information from smart identity cards or similar. This approach simplifies the process of personalizing the media distributed to a particular user.

According to still a further embodiment the administrative system 4 comprises means (not shown) for collecting and compiling statistical data during a user session. Hereby facilitating printout or electronic delivery of personalized documentation or a summary of what media a user has accessed and provide adapted material. Such statistics would likely also be useful when the system is used in a sales area or similar, for providing marketing feedback and information relating to which media has attracted most consumer interest.

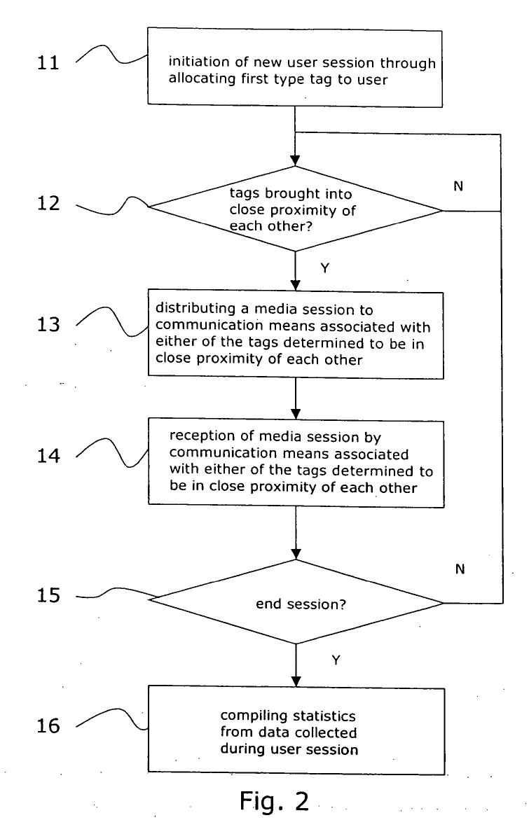

FIG. 2 shows a simplified flow sheet illustrating use of the system for media distribution in a physical area 1. It is hereby assumed that a selected physical area 1 has been provided with a plurality of uniquely identifiable second type tags 3, identifying media access points in said physical area 1 as well as an administrative system 4 and means 5, 7, 8 for providing communication between different components of the system. As illustrated in FIG. 2, the first step 11 therefore represent the initiation of a new user session through allocating a uniquely identifiable first type tag 2 to a user, which first type tag 2 can be carried around said physical area 1 by the user being visitor thereto. As at least one of said first and second type tags 2, 3 are provided with means 6 for identifying combinations of first and second type tags brought into close proximity of each other, step 12 illustrates alternatives paths in the flow sheet, depending upon if proximity of tags have been determined and authorized for communication to the administrative system 4 or not. In the later case the system resumes trying to identify if combinations of first and second type tags 2, 3 have been brought into close proximity of each other and in the first case, information relating to the tags determined to have been brought into close proximity of each other is communicated to the administrative system 4. Step 13 illustrates the administrative system 4 responding to the information communicated through distributing to communication means 7, 8 associated with either of these tags media determined by the received information, e.g. a media session determined by the second type tag 3 which can be personalized based upon the identity provided by the first type tag 2. Step 14 illustrates the reception of the media session by communication means 7, 8 associated with either of the tags determined to be in close proximity of each other, whereupon it is envisaged that this media is presented to the user through presentation means (not shown) either integrated into the communication means 7, 8 or associated therewith. Hereby information can be distributed either to the communication means 7 associated with the first type tag 2 carried by the user or to communication means 8 associated with the media access point represented by the second type tag 3 or to both these communication means 7, 8 for subsequent presentation to the user. In step 15 it is determined if the user wishes to end the session, or resume browsing the physical area 1 for additional media access points 3. In the later case, the system resumes at step 12, while in the first case, i.e. when the user wishes to end the session, the session is wrapped up in step 16 through the administrative system 4 compiling statistics from data collected during the user session.

In the following, examples will be used to illustrate how the system could be implemented in different physical environments.

Presented as a first example is a method of media distribution and data collection in exhibit and event environments, such as trade fairs and other presentational activities. The same method is usable for accessing sales medial connecting sales personnel with product specialists and method of collecting sales related customer information based on the natural sales person and customer meeting in stores, which is of particular relevance for national or global retail store chains but general to retailing. The following steps provide a simplified description of how the system can be used. Initially it is envisaged that a potential customer approaches a sales person. The sales person registers a new session to the system, i.e. allocates a first type tag 2 to the sales session, and shows the potential customer around the sales area 1. The sales person may also register the customers identity through a membership card or similar or by simply asking for it. However, the potential customer may remain anonymous. The potential customer and sales person approach a product placed in the sales area and starts talking about it. As the potential customer asks questions about the product the sales person points an interaction device comprising the first type tag 2 towards a location tag, i.e. second type tag 3, placed on the product or in the exhibit booth or located in the store. Depending on the type of product it might have several related second type tags 3. Through approving communication relating to the combination of the tags the sales person communicates to the administrative system 4 what products or parts of products or aspects for products they are talking about. Certain second type tags 3 may also direct presentation media, such as information about price or technical specifications, animations, commercials etc. to screens, audio systems, mobile phones, hand held personal computers (PCs) and so forth associated with the sales location as identified by the second type tag 3. This presentation media can be distributed to communication means 8 associated with the second type tag 3 through a wired or possibly wireless network. The sales person may use this both as a memory support to present the correct product specifications and also to be able to present more advanced information to the customer. Certain second type tags 3 may also be encoded to initiate direction of a telephone call or video conference activity to a product specialist located somewhere else in the world. As the customer is about to leave the sales area 1 e.g. a store or exhibition area, the sales person may finish the session and thereby initiate collection of statistics from the sales meeting and the printout or electronic delivery of a personalized documentation of the customers session in the sales area, such as a personal website, a printed documentation, or a profile to a general web site of the exhibitor or retailer.

A further example presents a method of media distribution in a physical area 1, such as a museum, a tourist attraction site or similar, that allow users to use their own personal communication devices such as mobile phones for controlling the distribution of media on a personal level. The following steps provides a simplified description of how the system can be used. A user requests the media distribution service and enters one or more network identifications of communication devices 7, such as mobile phone numbers or network card addresses, into an administrative system 4. The system provides a tangible first type tag 2 that can be carried around the physical area and which is associated with the personal communication devices 7. The user walks around in the physical area 1 wherein place tags, i.e. second type tags 3, have been distributed as media access points. When the user finds a media access point of interest, the first type tag 2 is brought into proximity of the second type tag 3 representing the media access point in order to activate the desired media session. Information containing the first type tag id and the second type tag id is communicated to the administrative system 4. The administrative system 4 responds by distributing media, identified by the second type tag 3, to the communication devices 7 initially identified to the system. The user receives the media to their personal communication devices 7, which media itself may contain more access points to new media in the form of hyperlinks. Upon finishing a session or possibly after a session the system may be asked to compile a summary of what media a user looked at, identified to the system by the unique identity of the first type tag 2, and provide an adapted material.

A method for media distribution in a physical area 1 as described above comprises the following steps. Providing at least one uniquely identifiable first type tag 2, which can be carried around said physical area 1 by a user being visitor thereto and providing at least one uniquely identifiable second type tag 3, identifying a media access point in said physical area 1. The method further comprises the steps of providing an administrative system 4 and providing communication means 5, 7, 8 enabling communication between the components of the system. In order to enable the distribution of media in the physical area 1 the method also comprises the steps of providing at least one of said first and second type tags 2, 3 with means 6 for identifying combinations of first and second type tags 2, 3 brought into close proximity of each other and means for communicating information relating to these tags to the administrative system 4 and arranging said administrative system 4 to respond to this information through distributing to communication means 7, 8 associated with either of these tags media determined by the received information. Which media can be personalized to the user based on the unique identity provided by the first type tag 2.

In a further embodiment of the method for media distribution in a physical area 1 the method further comprises the steps of associating an event manager with said administrative system 4 and embedding computer-readable events in the information identifying the tags 2, 3 brought into close proximity of each other and communicated to the administrative system 4.

According to yet a further embodiment of the method for media distribution in a physical area 1 the method further comprises the step of integrating the administrative system 4 in a communication means 7 associated with a first type tag 2. This communication means 7 could be constituted of a portable communication device 7, such as a personal mobile phone, associated with the first type tag 2. The communication device 7 can also comprise or be associated with means for presenting audio or audio-visual media.

In still a further embodiment of the method for media distribution in a physical area 1 the method further comprises the step of providing said first type tag 2 with means (not shown) for facilitating determination of a user identity to said system. This is achieved through providing the first type tag 2, or the communication means 7 associated therewith, with identification means, such as biosensors, e.g. a fingerprint reader or a retinal recognition device, or readers for identity information from smart identity cards or similar. This approach simplifies the process of personalizing the media distributed to a particular user.

According to yet a further embodiment of the method for media distribution in a physical area 1 the method further comprises the step of providing the administrative system 4 with means (not shown) for collecting and compiling statistical data during a user session. Hereby facilitating printout or electronic delivery of personalized documentation or a summary of what media a user has accessed and provide adapted material. Such statistics would likely also be useful when the system is used in a sales area or similar, for providing marketing feedback and information relating to which media has attracted most consumer interest.

The invention is not limited to the above-described embodiments, but may be varied within the scope of the following claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A system for media distribution in a physical area comprising,
at least one uniquely identifiable tangible first type tag, which can be carried around said physical area by a user being visitor thereto;
at least one uniquely identifiable tangible second type tag, identifying a media access point in said physical area;
an administrative system;
communication means; and
wherein, at least one of said tangible first and second type tags has means for identifying combinations of tangible first and second type tags brought into close proximity of each other and communicate information relating to these tangible tags to the administrative system;
said administrative system being arranged to respond to this information through distributing to communication means associated with either of these tangible tags media determined by the received information.

12. A system according to claim 11, further comprising an event manager associated with said administrative system, wherein;
computer-readable events are embedded in the information identifying the tangible tags brought into close proximity of each other and communicated to the administrative system.

13. A system according to claim 11, wherein said administrative system is integrated in a communication means associated with a tangible first type tag.

14. A system according to claim 11, wherein said tangible first type tag comprises means for determining the identity of the user.

15. A system according to claim 11, wherein said administrative system comprises means for collecting and compiling statistics of a user session.

16. A method for media distribution in a physical area comprising the steps of:
providing at least one uniquely identifiable tangible first type tag, which can be carried around said physical area by a user being visitor thereto;
providing at least one uniquely identifiable tangible second type tag, identifying a media access point in said physical area;
providing an administrative system;
providing communication means;
providing at least one of said tangible first and second type tags with means for identifying combinations of tangible first and second type tags brought into close proximity of each other and means for communicating information relating to these tangible tags to the administrative system; and
arranging said administrative system to respond to this information through distributing to communication means associated with either of these tangible tags media determined by the received information.

17. A method according to claim 16, further comprising the steps of:
associating an event manager with said administrative system;
embedding computer-readable events in the information identifying the tangible tags brought into close proximity of each other and communicated to the administrative system.

18. A method according to claim 16, further comprising the step of:
integrating said administrative system in a communication means associated with a tangible first type tag.

19. A method according to claim 16, further comprising the step of:
providing said tangible first type tag with means for determining the identity of the user.

20. A method according to claim 16, further comprising the step of:
providing said administrative system with means for collecting and compiling statistics of a user session.
